(19) United States
(12) Patent Application Publication
(10) Pub. No.: US 2026/0024166 A1
(43) Pub. Date: Jan. 22, 2026

(54) CONFIDENCE-DEPENDENT IMAGE BRIGHTENING

(71) Applicant: Continental Autonomous Mobility Germany GmbH, Ingolstadt (DE)

(72) Inventors: Michelle Karg, Lindau (DE); Juan Mateo Castrillón Cuervo, Regensburg (DE); Christian Scharfenberger, Lindau (DE)

(73) Assignee: Continental Autonomous Mobility Germany GmbH, Ingolstadt (DE)

(21) Appl. No.: 19/121,027

(22) PCT Filed: Sep. 18, 2023
(86) PCT No.: PCT/DE2023/200189

§ 371 Date: Apr. 14, 2025

(30) Foreign Application Priority Data
Oct. 14, 2022 (DE) 10 2022 210 890.6

(51) Int. Cl. G06T 5/50; G06T 5/40; G06T 5/60

(52) U.S. Cl. CPC G06T 5/50; G06T 5/40; G06T 5/60; G06T 2207/20081; G06T 2207/20084; G06T 2207/30252

(57) ABSTRACT

A computer-implemented method is disclosed for brightening an image of a camera, the use of the method for use in an application in the field of computer vision or a system for data processing. The method includes: providing at least one raw data image of the camera; providing at least one first brightening image of the raw data image, wherein the first brightening image is brightened by means of a first brightening method; determining a first confidence for the brightening of the raw data image of the camera by the first brightening method; and reconstructing an output image at least in part from the raw data image and/or the first brightening image as a function of the first confidence.

### CROSS-REFERENCE TO RELATED APPLICATIONS

The present application is a National Stage Application under 35 U.S.C. § 371 of International Patent Application No. PCT/DE2023/200189 filed on Sep. 18, 2023,and claims priority from German Patent Application No. 10 2022 210 890.6 filed on Oct. 14, 2022, in the German Patent and Trademark Office, the disclosures of which are herein incorporated by reference in their entireties.

### TECHNICAL FIELD

The present invention relates to a method, in particular a computer-implemented method, for brightening an image of a camera.

### BACKGROUND

As a general rule, today's vehicles are equipped with cameras and have advanced driver assistance systems (ADAS) with an extremely wide variety of functions, for example for assisted and automated driving, or for displaying and supporting the driver during driving or parking by, e.g., displaying acquired images of the surroundings. Thus, in connection with driver assistance systems, various methods for recognizing objects or obstacles on the road, methods for recognizing road edges and/or for keeping the vehicle in a lane, methods for recognizing rain on the windshield, or methods for supporting or performing a parking process have become known. These and further functionalities are frequently based at least in part on images which are acquired by means of cameras fastened to the vehicle. The cameras are, for example, individual or multiple forward-looking or backward-looking cameras, or surround-view camera systems. Furthermore, the systems serve as the basis for automated driving functions for Automated Driving Systems (ADS).

In many cases, the acquired raw data images must be subjected to image processing prior to further processing in order to make the information contained in the images as visible as possible. However, the evaluation and image processing of raw data images from cameras play a decisive role not only in connection with driver assistance systems, but also in all other fields in which the image quality is to be improved compared to the raw data images. A central topic of the image preprocessing relates to dealing with variable lighting. Typically, the further processing of images which have been acquired in daylight conditions or in conditions with good lighting is unproblematic and perfectly possible both for visual and machine purposes. By contrast, dark scenarios or scenarios having high dynamics, e.g., scenarios which simultaneously have very bright and very dark regions, as in the case of night shots, frequently pose a challenge for image brightening methods.

In principle, both classic image processing methods and various approaches which take into account methods from the field of machine learning are deployed for brightening camera images. In the case of classic, filter-based image preprocessing such as, for example, in the case of approaches based on a histogram stretch, the entire bit and dynamic range of a raw data image is typically exploited and various brightness adjustments are made. Corresponding methods use local or global statistics in the images and calculate an adjustment to the image brightening therefrom. Alternatively, methods have also become known, in which only individual brightness ranges of pixels are considered and utilized for brightening. In principle, the disadvantage of this procedure can be that it leads to specific information in the raw data images not being taken into account, but which contains valuable information for image brightening. Additionally, some of the filter-based, classic methods can be difficult to implement in embedded systems.

In the case of image brightening methods which use methods from the field of machine learning, methods in which neural networks, in particular convolutional neural networks (CNN), are deployed have in particular become known. Typically, a brightened image is reconstructed based on training data having different exposure times. At the same time, image context is modeled in the neural network and taken into account during the respective brightening process. This is achieved by learning textures and structures, which provide the neural network with indications regarding specific types of brightening. Thus, local and global properties in the raw data images can be recognized and processed. Moreover, the neural network can also be trained with respect to image noise and can suppress the image noise at least in part.

In principle, the performance of neural networks depends, inter alia, on the quality of the training data, the model used and the input data. The quality of the output of the neural network can in turn be adversely affected by noisy input data, inadequate modeling capacity of the network and the processing of traffic densities which are not sufficiently illustrated by the training data.

For example, a machine learning method for the brightness conversion of input image data of a camera into output image data by means of an artificial neural network, by means of which brightness conversions of the input image data can be carried out, has become known from DE102019220168A1.

That is to say that, irrespective of the method used, it happens time and time again that the image brightening is not sufficient or produces poor-quality results. However, poorly brightened images can only be used, if required, to a limited extent for further processing. For example, it is important in the field of driver assistance systems to also be able to assess the quality of the image brightening carried out, in particular during further processing of the brightened images for safety-related functions. In this connection, dealing with various image artifacts such as color artifacts on edges, inter alia, is problematic. Image artifacts can also be induced by carrying out the image brightening. For example, it can happen that inherently well-illuminated regions in the raw data image are excessively brightened. The disparity of such well-illuminated and less well-illuminated regions within the raw data image is typically not sufficiently taken into account in the case of established methods.

### SUMMARY

Therefore, an object of the present disclosure is to provide a reliable possibility for assessing image brightening of raw data images.

This object is addressed by the method according to claim 1, by the use of a brightening image according to claim 12, the system for data processing according to claim 13, the computer program according to claim 14 as well as by the computer-readable storage medium according to claim 15.

With respect to the method, the object of the invention is addressed by a method, in particular a computer-implemented method, for brightening an image of a camera. The method includes the following method steps:
providing at least one raw data image of the camera,
providing at least one first brightening image of the raw data image, wherein the first brightening image is brightened by means of a first brightening method,
determining a first confidence for the brightening of the raw data image of the camera by means of the first brightening method, and
reconstructing an output image at least in part from the raw data image and/or the first brightening image as a function of the first confidence.

That is to say that, according to the present disclosure, a brightened output image is reconstructed as a function of a confidence. The output image can be composed of contributions from one or more different brightening images and from the raw data image. Taking the confidence into account is in particular important if the brightened output image is further processed, and the further processing depends on the image information of the output image.

The quality of a brightening method can advantageously be determined during the running time of the method and the reconstruction of the brightened image itself can be carried out as a function of the performance of different brightening methods. Furthermore, the computing time can be reduced by initially determining a brightening image plus a confidence while further brightening images are only generated if the confidence exceeds or falls short of a predefinable limit.

Image regions can be composed of different brightening images and/or the raw data image, i.e., different illumination in different image regions is addressed in a suitable manner. In this way, a distinction can be made, inter alia, between different image regions having different illumination. Reconstructing the output image as a function of the confidence also makes it possible that the image brightening can be adjusted, in particular instantly, to variable lighting situations such as, by way of example, switching on external lighting, for example in a garage.

The confidence can in principle be determined as a whole for a raw data image, or multiple confidence values can be determined for individual image regions or, in each case, one confidence value can be determined for each individual pixel of the raw data image. The determination of the confidence can be optimized in each case in a suitable manner in terms of the necessary computational effort. Moreover, if the determined confidence in specific image or pixel regions has similar or almost identical values, an average for the confidence can be established and used for the regions. Individual specific confidence values, which deviate significantly from an average for the confidence in a specific region or in the entire brightening image, can also not be taken into account.

In this connection, confidence is to be understood to be a measure of the quality of the brightening. It can be an estimated value or a calculated value. For example, the confidence can be indicated in the form of a probability. In order to reconstruct the brightened output image, rules can, for example, be stipulated, which assign a specific brightening image or the raw data image, or specific image regions in the brightening image or raw data image in each case to specific confidence values or predefinable intervals for the confidence values, which images or image regions are utilized to reconstruct the output image. Interpolations between the brightening images and/or the raw data image can also be utilized.

In one embodiment, the method according to the present disclosure additionally includes the following method steps:
providing at least one second brightening image of the raw data image, wherein the second brightening image is brightened by means of a second brightening method which differs from the first brightening method, and
reconstructing the output image at least in part from the raw data image, the first brightening image and/or the second brightening image as a function of the first confidence.

That is to say, the raw data image is brightened by means of two different brightening methods and a confidence is determined for at least one of the two brightening images, which is utilized to reconstruct the output image. Both brightening images as well as the raw data image, or only one or two of the at least three images, can be utilized for reconstruction. The selection is also made as a function of the confidence determined.

In this connection, it is advantageous if a second confidence for the brightening of the raw data image of the camera is determined by means of the second brightening method, wherein the output image is reconstructed at least in part from the raw data image, the first brightening image and/or the second brightening image as a function of the first and/or second confidence. In this case, two confidences, in particular those determined independently of one another, can also be utilized to reconstruct the output image. The two confidences can be considered separately of one another. However, it is equally conceivable to determine a total confidence on the basis of the two confidences, and to utilize the total confidence to reconstruct the output image.

According to the present disclosure, one or more different brightening methods can accordingly be used to brighten a raw data image. The final output image is reconstructed as a function of the confidence and, consequently, leads to optimal brightening with a high quality, in which the occurrence of artifacts can be minimized.

It is also conceivable to configure the method according to the present disclosure iteratively. In this case, the individual method steps are repeated, for example until such time as a predefinable limit for the confidence has been exceeded or fallen short of. During individual runs of the image brightening, confidence establishment and reconstruction, different methods or the same methods with different parameters can be used. In this way, for example, a minimum standard for the image brightening can be predefined and constantly achieved.

In one embodiment of the method, at least one of the brightening methods is at least in part a statistical brightening method, such as a filter-based method, in particular a histogram stretch method, a tone mapping method, a white balance method, or a combination of multiple of the indicated methods with one another and/or with further methods.

In a further embodiment, at least one of the brightening methods is a method based on a machine learning method, such as a method using one or more neural networks, in particular a convolutional neural network, an adversarial neural network, a recurrent neural network, a transformer network, a graph neural network, or a neural circuit, or a deep learning method, in particular using a neural network having a plurality of implicit layers.

In this connection, it is advantageous if the neural network is a trained neural network which is configured to determine a brightening image starting from an input in the form of at least one raw data image of a camera, which brightening image corresponds in particular to an image corresponding to the raw data image having a longer exposure time.

In an example embodiment of the method, the output image is at least reconstructed in a sub-region from an interpolation of the raw data image, the first brightening image and/or the second brightening image. With respect to the interpolation, the first and/or possibly likewise determined second confidence can be utilized as a weighting measure.

According to a further embodiment, it is consequently likewise possible to utilize the determined first and/or second confidence as a weighting measure or weighting factor. In this case, the output image may be reconstructed on the basis of a superposition of the raw data image, the first brightening image and/or the second brightening image, wherein the first and/or second confidence weights contributions of the raw data image and the brightening image(s) for different regions or individual pixels.

It is advantageous if the confidence is information about the quality of the brightening of the raw data image of the camera, in particular an uncertainty measure for the brightening. That is to say that, in connection with the present disclosure, confidence is understood to be a measure of the quality of the image brightening method used in each case. In principle, it is a measure, for example an estimated value, of the reliability of the image brightening.

The confidence can be determined in an extremely wide variety of ways, in particular depending on the brightening method used. If the confidence is expressed in the form of a confidence measure, the output image is interpreted probabilistically as the probability with which a correct image brightening of the raw data image has been carried out. However, the confidence can also be expressed, for example, in the form of an uncertainty measure similar to a standard deviation. An uncertainty for the output image can be estimated in such a way that it describes a scatter with respect to the reconstruction. In this connection, uncertainties which are caused by the raw data image itself, and uncertainties which are caused by the limited brightening accuracy of the respective method can be taken into account, for example. In the event that a neural network is used for brightening, the extent and/or the quality of the training data can additionally be taken into account. A combination of the confidence measure and the uncertainty measure can also be utilized to describe the confidence. Furthermore, an uncertainty measure can be interpreted as a confidence measure by calibration.

Moreover, numerous further possibilities of establishing confidence are conceivable and likewise fall within the scope of the present disclosure. For example, a brightening image generated by means of a specific brightening method can be subjected to a predefinable image transformation, in particular a mirroring, a filter, or similar. The brightening image and the transformed, filtered, or otherwise modified brightening image are then compared with one another in a second step, wherein the confidence of the brightening method results from the degree of concurrence between the two images. The confidence of a brightening method, in particular in the event that it is a method based on a machine learning method, can also be determined on the basis of ensembles of neural networks. Multiple neural networks are trained to achieve the same object. The networks can differ with respect to their architecture, the training data used to train the networks, their weighting factors, a loss function, or other parameters. The confidence can then be determined on the basis of the degree of concurrence of the ensemble.

A further possibility is to determine the confidence on the basis of an output distribution in which the output of a neural network which is used for image brightening of the raw data image is modeled with a distribution function. The variance of the distribution function then indicates the confidence. Finally, the confidence can also be determined on the basis of an epistemic uncertainty. In this case, a distribution is approximated by way of the weights of a neural network, for example on the basis of a Monte Carlo dropout or on the basis of a Bayesian network. The confidence can then be calculated from the uncertainty which results from the effect of these distributions of the weights on the output of the neural network. For example, the output of a probabilistic neural network can be sampled multiple times and the average and the standard deviation or the variance for these samples can be calculated.

In one embodiment of the method according to the present disclosure, at least one limit is predefined for the confidence, wherein the output image is reconstructed at least in part from the raw data image if the confidence falls short of the predefinable limit, and wherein the output image is reconstructed at least in part from the first brightening image if a confidence exceeds the predefinable limit. Alternatively, the reconstruction can also take place from the raw data image if the confidence exceeds the predefinable limit and from the brightening image if it falls short of the limit. In the event that more than one brightening method is used, intervals can also be predefined for the confidence, wherein a specific brightening image is utilized for the reconstruction if the confidence lies in the respective interval.

In an advantageous embodiment of the method according to the present disclosure, a confidence map is determined, which contains a value for the confidence for at least two sub-regions of the raw data image, such as for each pixel of the raw data image, and wherein the output image is reconstructed as a function of the confidence map.

In this connection, it is advantageous if sub-regions of the raw data image having values for the confidence, the difference of which does not exceed a predefinable limit, are combined to form a predefinable confidence region. That is to say that regions having similar confidence values are aggregated. For example, an average for the confidence can be determined for specific sub-regions of the raw data image and indicated in the confidence map.

The reconstructed output image, according to the present disclosure, may be used for an application in the field of computer vision, such as for a function in a driver assistance system in a motor vehicle, in particular for a method for recognizing at least one traffic sign or a traffic-related object. Traffic-related objects are, for example, various road users such as pedestrians, cyclists or motorcyclists, other vehicles such as, e.g., trucks, motor vehicles, buses or trains, and road markings. It is likewise conceivable to determine the intentions of road users on the basis of the output image. Moreover, an optical flow or a depth map can be determined. However, the output image can also be utilized for any object recognition or can also serve directly for display purposes without resulting in any computer-aided further processing or similar. For example, the output image can be displayed on a display to a viewer who himself derives information or actions therefrom, for example in the case of supporting a parking process of a vehicle.

The object of the present disclosure is further achieved by a system for data processing, including means for executing the method according to the present disclosure according to one of the described embodiments, by a computer program including commands which, when the program is executed by a computer, prompt the computer to execute the method according to the present disclosure according to one of the described embodiments, and by a computer-readable storage medium on which the computer program according to the present disclosure is stored.

### BRIEF DESCRIPTION OF THE DRAWINGS

The present disclosure as well as its advantageous embodiments are explained in more detail with reference to the following figures, wherein:

FIG. 1 shows night shots of two different scenes in the form of raw data images and images brightened by means of a brightening process;

FIG. 2 shows a diagram in order to illustrate a first example embodiment of the method according to the present disclosure using a brightening process;

FIG. 3 shows a diagram in order to illustrate two further example embodiments of the method according to the present disclosure using two or more brightening processes; and

FIG. 4 shows a flow chart for an example embodiment of the method according to the present disclosure.

### DETAILED DESCRIPTION

The same elements are in each case provided with the same reference numeral below.

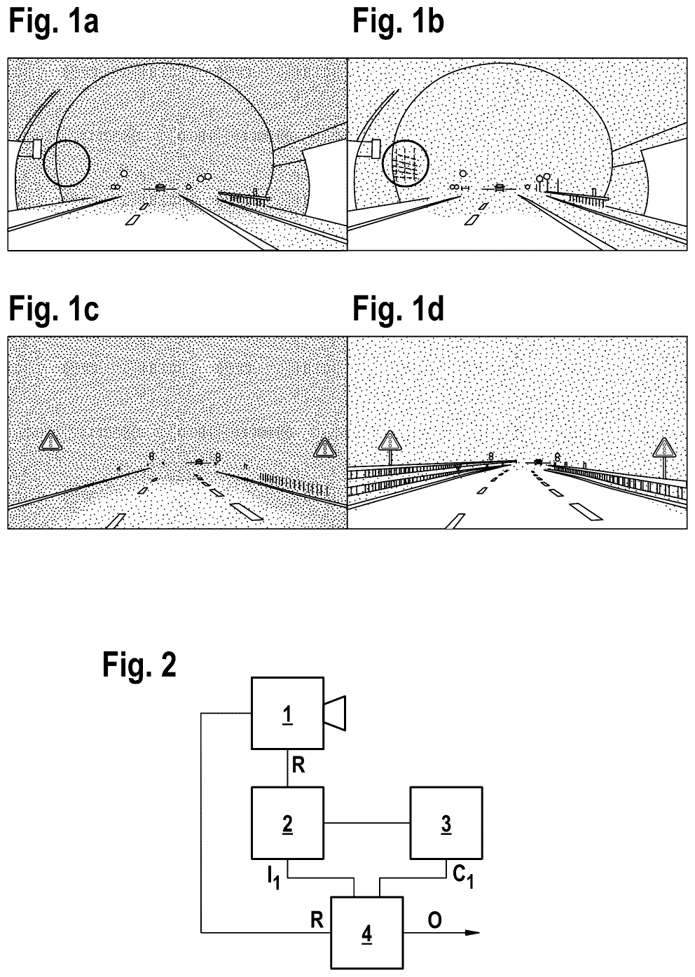

In the case of night shots having inadequate lighting, image brightening is frequently necessary prior to further processing of the acquired images. As already explained, both various classic methods and methods for which methods from the field of machine learning are deployed at least in part are available for image brightening. However, such methods have different problems, as explained by way of example with reference to FIG. 1.

A raw data image of a night shot of a tunnel exit is depicted in FIG. 1a. FIG. 1b shows a brightening image of the same scene, which is obtained using a correspondingly trained convolutional neural network (CNN). In the region of the sky, the raw data image (FIG. 1a) contains only little image information, whilst a structure which is an error in the image processing (region circled in white) can be seen in the brightened image (FIG. 1b).

A raw data image of a night shot of a country road is shown in FIG. 1c, whilst a brightening image of the same scene, which is likewise obtained using a correspondingly trained convolutional neural network (CNN) is depicted in FIG. 1d. Here, in the region of the night sky, stripes can be seen in the brightening image from FIG. 1d which are missing in the raw data image (FIG. 1c). During image brightening, sensor noise of the camera has been falsely processed as data information.

Similar problems also exist when using classic, in particular statistical, methods for image brightening.

The present disclosure leads to a significant improvement in the image brightening of raw data images of a camera. In particular, the robustness of the image brightening is increased by reconstructing the final output image from different brightening images and/or the raw data image. The proposed reconstruction is based on the determination of a confidence for at least one of the brightening methods used.

For example, in the case of FIGS. 1a and 1b, it would seem appropriate to use the raw data image, or a brightening image obtained by means of another method, or an interpolation from the brightening image according to FIG. 1b and a further brightening image and/or the raw data image in the region of the sky for the creation of the output image. By contrast, in the case of the scene shown in FIGS. 1c and 1d, it would be advantageous to use the raw data image, for example, to create the output region in the image region which represents the sky.

A first exemplary embodiment of the method according to the present disclosure is illustrated in FIG. 2. In a first method step 1, a raw data image 1 of a camera is provided. In a further method step 2, a first brightening image I1 brightened by means of a first brightening method is created from the raw data image R, and in step 3 a first confidence C₁ for the brightening of the raw data image R is determined by means of the first brightening method. Finally, in step 4, an output image O is reconstructed from the raw data image R and/or the first brightening image I₁ as a function of the first confidence C₁. Depending on the value for the confidence C₁, the output image O can be reconstructed at least in part or completely from the raw data image R, the brightening image I₁, or an interpolation of both. In principle, the output image O for different image regions can consist of different brightening images I and/or the raw data image R.

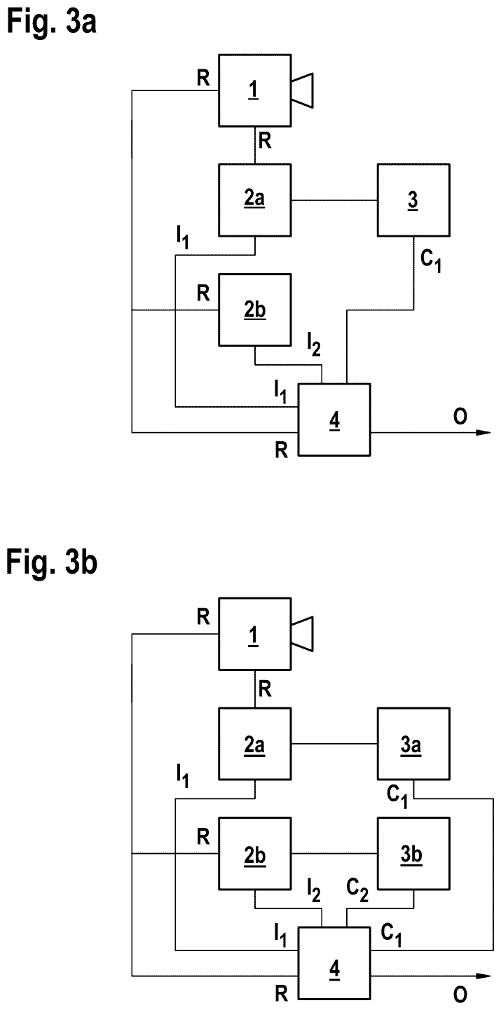

Two further possible embodiments of a method according to the present disclosure are depicted in FIG. 3. In addition to the method steps as they have been depicted in FIG. 2, in the case of the embodiment according to FIG. 3a, in addition to the first brightening image I₁ according to method step 2a, a second brightening image I₂ is in addition created by means of a second brightening method which differs from the first brightening method (step 2b) and is taken into account during the reconstruction of the output image O. Whilst no separate confidence C is determined for the image brightening by means of the second brightening method for the embodiment according to FIG. 3a, the embodiment according to FIG. 3b involves a first confidence C₁ and a second confidence C₂ being determined in each case (steps 3a and 3b) for both image brightening processes (steps 2a and 2b). In other embodiments, further brightening methods can also be performed and/or confidences C can be determined, which can be taken into account during the reconstruction of the output image O.

According to the present disclosure, the image brightening can be carried out both by means of a classic brightening method and by means of a method based on a machine learning method. Depending on the image brightening method used, the confidence C can be determined in a suitable manner.

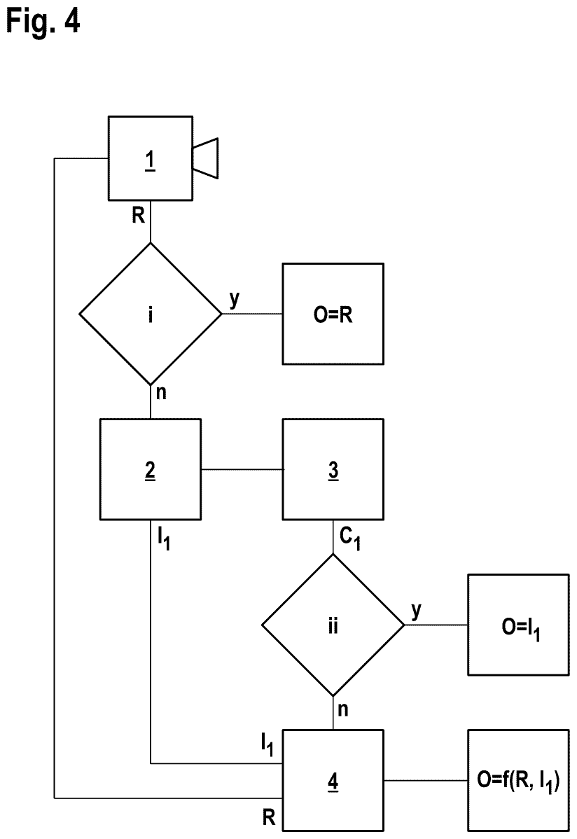

A further example embodiment of the method is illustrated in FIG. 4. After receiving a raw data image R from the camera 1, it is initially checked in checking step i whether the raw data image R is sufficiently illuminated. If this is the case, the raw data image R is used as the output image O. If this is not the case, the image is brightened (step 2) and the confidence C for the image brightening is determined (step 3). A brightening method can be used, as depicted in FIG. 4 and similarly to the embodiment from FIG. 2. However, multiple brightening methods can also be used, for example similarly to the embodiments according to FIG. 3.

If the determined confidence C meets a predefinable criterion (decision step ii), such as, for example, exceeding or falling short of a predefinable limit, the brightening image I₁ is used as the output image O. Otherwise, the output image is reconstructed from the brightening image |1 and/or the raw data image R according to step 4. During the reconstruction, the output image O can be composed either in different image regions from the brightening image I₁ or the raw data image O. Alternatively, an interpolation of both images can also take place, for which the confidence C can serve as a weighting measure, for example.

For the embodiment depicted in FIG. 4, it is assumed, without restricting the generality, that the brightening method in step 2 is a method based on a machine learning method, for example using a convolutional neural network (CNN). The neural network can then be extended by an additional confidence estimate to determine the confidence for the image brightening. To determine the confidence C, an estimate can be determined as to how reliably the network can predict its output. That is to say that, in general, the confidence determination is based on the calculation of an uncertainty measure. In this respect, a distinction can be made between an epistemic and aleatoric uncertainty.

Determined confidences C can be calibrated in a further method step, for example so that the values can be interpreted probabilistically. The calibration of the confidences C or uncertainty measures can, inter alia, serve the comparability of the confidence C for different image regions and raw data images R. The calibrated confidence C can, for example, assume values in the interval between [0;1] and can be interpreted as the probability with which the neural network estimates to calculate a correct prediction.

Examples of a confidence establishment for neural networks are described, inter alia, in “What uncertainties do we need in Bayesian deep learning for computer vision?” by A. Kendall et al., published in Advances in Neural Information Processing Systems, vol. 30, 2017; in “Can you trust your model's uncertainty? Evaluating predictive uncertainty under dataset shift” by Y. Ovadia et al., published in Advances in Neural Information Processing Systems, vol. 32, 2019, in “A review of uncertainty quantification in deep learning: Techniques, applications and challenges” by M. Abdar et al., published in Information Fusion 76, pp. 243, 297, 2021, or in “Accurate uncertainties for deep learning using calibrated regression” by V. Kuleshov et al., International Conference on machine learning PMLR, 2018.

When determining the confidence by way of the aleatoric uncertainty, the network output is modeled as a distribution function. To this end, further outputs are added to the neural network, which represent the parameters of the distribution function. Furthermore, the cost function can be adjusted in such a way that the error between the expected distribution of the population and the existing distribution from the available data is minimized. The Kullback-Leibler divergence can in turn be used as a measure of the difference of the distributions. This corresponds to a maximum likelihood estimate for the network parameters.

On the one hand, it is conceivable to determine a value for the confidence C for each raw data image R, or values for the confidence C can be determined for individual image regions and edited in the form of a confidence map. If a confidence C is determined separately for each pixel of the raw data image R, the result is a confidence map having the same resolution as that of the raw data image R or output image O.

Confidence maps can further be optionally filtered, for example with a low-pass filter, in order to reduce the influence of values for the confidence C having a high deviation from a confidence average. Image regions having similar confidence values C can also be aggregated in a suitable manner, which can in turn stabilize the reconstruction of the output image O. It is additionally possible to optimize a confidence map in terms of the computational effort, for example when implementing the method in an embedded system. This can be effected by reducing the numerical representation of the values for the confidence, for example to 8, 16 or 32 values in the range [0;1]. In this case, the resolution can be adjusted to the integer data format, e.g., 3 bits for 8 values. For this approach, confidence values C are clustered, cluster centers are calculated, and the individual values are assigned to the cluster centers. In a possible extension, the cluster centers can be saved in a look-up table and represent any value.

It is equally conceivable to combine the images in order to calculate a semantic segmentation, for example with a determined confidence map. For image regions having the same or similar semantics, an average can then be calculated, for example, for the confidence C.

In the event that multiple brightening methods are to be taken into account using methods from the field of machine learning, various neural networks, in particular networks having different architectures, for example convolutional neural networks, transformer networks, or, in particular generative, adversarial networks, different parameters, different learned weights of the network due to different training, for example city and country scenes, different layers, for example different layers for the final reconstruction, or at least partially different additional functions, can, for example, be used for example for object detection, depth calculation, calculation of the optical flow, or semantic segmentation.

In principle, within the framework of the present disclosure, the brightening image I having the best, in particular highest, confidence C or the raw data image R is utilized for the reconstruction for each raw data image R, each image region of a raw data image R, or for each pixel of a raw data image R. In this way, an optimal brightened output image O is generated for a specific raw data image R from multiple possible brightening methods. That is to say that uncertainties in the conventional image brightening can be compensated for by a clever, at least partially confidence-controlled, combination of different image brightening methods.

The raw data image R, or a brightening image I, for which no confidence C has been determined, can then be utilized for reconstruction, for example, in such cases, if the confidence C is too poor, in particular too low for another brightening method. Of course, a good-quality image brightening of the image brightening method for which a confidence C is available can then no longer be guaranteed. By contrast, in the case of a high level of certainty for the image brightening, that is to say a good, in particular high confidence C, the brightening image I can be used. The selection from the various available images R, I can also be effected differently for various image regions or separately for each pixel. Moreover, an interpolation can be formed from the original image R and/or various brightening images I, for which the confidence C or confidence map is utilized as a weighting measure. The output image is then composed of weighted input images and a standardization. The standardization combines, for example, the weights per pixel, image region or image and standardizes the sum of the weights to 1. For the raw data image R and/or for those brightening images I for which no confidence C was determined, an inverted, available confidence C or confidence map can then be utilized for weighting.

1. A computer-implemented method for brightening an image of a camera, the method comprising:
providing at least one raw data image of the camera,
providing at least one first brightening image of the raw data image, wherein the first brightening image is brightened by a first brightening method,
determining a first confidence for the brightening of the raw data image of the camera by the first brightening method, and
reconstructing an output image at least in part from at least one of the raw data image and/or the first brightening image as a function of the first confidence.

2. The method according to claim 1, further comprising:
providing at least one second brightening image of the raw data image, wherein the second brightening image is brightened by a second brightening method which differs from the first brightening method, and
reconstructing the output image at least in part from at least one of the raw data image, the first brightening image or the second brightening image as a function of the first confidence.

3. The method according to claim 2, further comprising determining a second confidence for the brightening of the raw data image of the camera by the second brightening method, wherein the output image is reconstructed at least in part from at least one of the raw data image, the first brightening image or the second brightening image as a function of at least one of the first or second confidence.

4. The method according to claim 2, wherein at least one of the first brightening method or the second brightening methods is at least in part a statistical, filter-based brightening method.

5. The method according to claim 2, wherein at least one of the first brightening method of the second brightening method is a method based on a machine learning method.

6. The method according to claim 5, wherein the one or more neural network is a trained neural network which is configured to determine a brightening image starting from an input in a form of at least one raw data image of the camera, which brightening image corresponds to an image corresponding to the raw data image having a longer exposure time.

7. The method according to claim 2, wherein the output image is at least reconstructed in a sub-region from an interpolation of the at least one of the raw data image, the first brightening image or the second brightening image.

8. The method according to claim 1, wherein the confidence is information about a quality of the brightening of the raw data image of the camera.

9. The method according to claim 1, wherein at least one predefinable limit is predefined for the confidence, and wherein the output image is reconstructed at least in part from the raw data image if the confidence falls short of the predefinable limit, and wherein the output image is reconstructed at least in part from the first brightening image if a confidence exceeds the predefinable limit.

10. The method according to claim 1, further comprising determining a confidence map which contains a value for the confidence for at least two sub-regions of the raw data image for each pixel of the raw data image, wherein the output image is reconstructed as a function of the confidence map.

11. The method according to claim 10, wherein the at least two sub-regions of the raw data image have values for the confidence, a difference of the confidence values does not exceed a predefinable limit and are combined to form a predefinable confidence region.

12. The method according to claim 1, further comprising using the output image for performing a function in a driver assistance system in a motor vehicle, in recognizing at least one traffic sign or a traffic-related object.

13. A system for data processing, comprising a computer processor configured by a computer program for executing a method according to claim 1.

14. A computer program maintained on a non-transitory storage medium and comprising commands which, when the computer program is executed by a computer, prompt the computer to execute the method according to claim 1.

15. The non-transitory computer-readable storage medium on which the computer program according to claim 14 is stored.

16. The method according to claim 4, wherein the at least one of the first brightening method or the second brightening method is a histogram stretch method, a tone mapping method, a white balance method, or a combination thereof.

17. The method according to claim 5, wherein the one or more neural networks comprises a convolutional neural network, an adversarial neural network, a recurrent neural network, a transformer network, a graph neural network, or a neural circuit.

18. The method according to claim 5, wherein the machine learning method comprises a deep learning method using a neural network having a plurality of implicit layers.

19. The method according to claim 8, wherein the quality of the brightening of the raw data image of the camera comprises an uncertainty measure for the brightening.
